(19) United States
(12) Patent Application Publication
(10) Pub. No.: US 2015/0247878 A1
(43) Pub. Date: Sep. 3, 2015

(54) ANGULAR ACCELERATION SENSOR

(71) Applicant: Murata Manufacturing Co., Ltd., Nagaokakyo-shi (JP)

(72) Inventor: Masayuki ICHIMARU, Nagaokakyo-shi (JP)

(21) Appl. No.: 14/714,539

(22) Filed: May 18, 2015

Related U.S. Application Data
(63) Continuation of application No. PCT/JP2013/080742, filed on Nov. 14, 2013.

(30) Foreign Application Priority Data
Nov. 19, 2012 (JP) 2012-253486

(51) Int. Cl. G01P 15/09

(52) U.S. Cl. CPC G01P 15/0922

(57) ABSTRACT

An angular acceleration sensor includes a flat plate surface, a fixed portion, a weight portion, and a beam portion. The weight portion includes a recessed portion that is recessed in an X-axis negative direction in the flat plate surface. The fixed portion includes a projecting portion projecting in the X-axis negative direction in the flat plate surface to be opposed to the recessed portion, and a slit extending inward in an X-axis positive direction from a position adjacent to the projecting portion. The beam portion extends along the Y-axis in the flat plate surface, is connected between the recessed portion and the projecting portion, and supports the weight portion movably relative to the fixed portion.

### BACKGROUND OF THE INVENTION

1. Field of the Invention

The present invention relates to an angular acceleration sensor that detects the angular acceleration from stress generated in a beam portion.

2. Description of the Related Art

An angular acceleration sensor includes a fixed portion, a weight portion, a beam portion, and a detection portion. The weight portion is elastically supported relative to the fixed portion by the beam portion. The detection portion is configured to detect the angular acceleration acting on the weight portion from stress generated in the beam portion.

A certain type of angular acceleration sensor is rotationally symmetrical to have rotational balance centered on the gravitational center position of a weight portion, and a plurality of beam portions are disposed around the gravitational center position of the weight portion (see, for example, Japanese Patent No. 2602300 and Japanese Unexamined Patent Application Publication No. 2010-139263). By achieving rotational balance centered on the gravitational center position of the weight portion, stress generated in the beam portions by the action of the angular acceleration can be detected while removing the influence of stress generated in the beam portions by the action of the acceleration. This increases the detection accuracy.

However, when a plurality of beam portions are provided so that the angular acceleration sensor is rotationally symmetrical, an inertial force received by the weight portion due to the angular acceleration is transmitted to the beam portions in a distributed manner. Thus, when the angular acceleration sensor is configured to have a predetermined natural frequency, stress generated per angular acceleration in the beam portions is reduced, and this lowers the detection sensitivity to the angular acceleration.

In the angular acceleration sensor, when deflection or torsion occurs in the fixed portion, distortion of the fixed portion is transmitted to the beam portions, and an unnecessary detection signal is output although the angular acceleration is not applied. This lowers the detection accuracy of the angular acceleration.

### SUMMARY OF THE INVENTION

Preferred embodiments of the present invention provide an angular acceleration sensor that achieves high detection sensitivity and high detection accuracy by concentrating generated stress in a beam portion while ensuring rotational balance centered on the gravitational center position of a weight portion and preventing transmission of distortion of a fixed portion to the beam portion.

A preferred embodiment of the present invention relates to an angular acceleration sensor including a flat plate surface, a fixed portion, a weight portion, a beam portion, and a detection portion. The weight portion includes a recessed portion that is recessed in a first direction in the flat plate surface. The fixed portion includes a projecting portion that projects in the first direction in the flat plate surface to be opposed to the recessed portion. The beam portion extends from the projecting portion in a second direction perpendicular or substantially perpendicular to the first direction in the flat plate surface, and is connected to the recessed portion at an end portion in the second direction. The detection portion detects stress generated in the beam portion. A slit extending in a direction intersecting the second direction in the flat plate surface extends inward in the fixed portion.

Since the beam portion is disposed between the projecting portion of the fixed portion and the recessed portion of the weight portion in this structure, the beam portion is disposed in proximity to the gravitational center position of the weight portion, and rotational balance centered on the gravitational center position of the weight portion is ensured. Further, there is no need to dispose a plurality of beam portions around the gravitational center position of the weight portion, and stress concentrates in the beam portion. Moreover, since the slit extending from the projecting portion in the direction intersecting the second direction extends inward in the fixed portion, even when deflection or torsion occurs in the fixed portion, distortion is unlikely to occur in the projecting portion. This reduces distortion to be transmitted to the beam portion.

In the above-described structure, the slit may extend in a direction opposite from the first direction in the flat plate surface, may extend in a direction opposite from the second direction, bend, and extend in the direction opposite from the first direction, or may extend in a direction intersecting the first direction and the second direction.

In the above-described structure, the fixed portion is preferably shaped to surround a periphery of the weight portion in the flat plate surface.

Since the weight portion is surrounded by the fixed portion in this structure, the fixed portion is utilized as a portion of a package structure. Further, in this structure, the fixed portion is relatively large, and is subject to deflection or torsion when it receives external force. Therefore, a marked effect is obtained by providing the slit in the fixed portion to prevent propagation of distortion to the beam portion.

According to various preferred embodiments of the present invention, since the weight portion includes the recessed portion and the projecting portion of the fixed portion and the beam portion are disposed within the recessed portion, the beam portion is disposed in proximity to the gravitational center position of the weight portion, and rotational balance centered on the gravitational center position of the weight portion is ensured. Therefore, stress generated in the beam portion by the action of the angular acceleration is detected while removing the influence of stress generated in the beam portion by the action of the acceleration.

Since there is no need to dispose a plurality of beam portions around the gravitational center position of the weight portion, the inertial force received by the weight portion due to the angular acceleration is transmitted in a concentrated manner to the beam portion provided between the recessed portion and the projecting portion. This increases the stress generated in the beam portion.

Further, since the slit extending from the projecting portion in the direction intersecting the second direction extends inward in the fixed portion, even when deflection or torsion occurs in the fixed portion, distortion is unlikely to occur in the projecting portion, and this reduces distortion to be transmitted to the beam portion. Therefore, it is possible to prevent output of an unnecessary detection signal when deflection or torsion occurs in the fixed portion although the angular acceleration is not applied.

Accordingly, various preferred embodiments of the present invention improve the detection sensitivity and the detection accuracy of the angular acceleration.

The above and other elements, features, steps, characteristics and advantages of the present invention will become more apparent from the following detailed description of the preferred embodiments with reference to the attached drawings.

### BRIEF DESCRIPTION OF THE DRAWINGS

FIGS. 1A and 1B are explanatory views illustrating the structure of an angular acceleration sensor according to a first preferred embodiment of the present invention.

FIGS. 2A and 2B includes explanatory views illustrating the circuit configuration of the angular acceleration sensor of the first preferred embodiment of the present invention.

FIG. 3 is an explanatory view illustrating the structure of an angular acceleration sensor according to a second preferred embodiment of the present invention.

FIG. 4 is an explanatory view illustrating the structure of an angular acceleration sensor according to a third preferred embodiment of the present invention.

FIG. 5 is an explanatory view illustrating the structure of an angular acceleration sensor according to a fourth preferred embodiment of the present invention.

FIGS. 6A-6C are explanatory views showing the stress distribution when torsion is applied to a fixed portion.

### DETAILED DESCRIPTION OF THE PREFERRED EMBODIMENTS

In the following description, an axis perpendicular to a flat plate surface included in an angular acceleration sensor is referred to as a Z-axis of a rectangular coordinate system, an axis along an extending direction of a beam portion in the flat plate surface is referred to as a Y-axis of the rectangular coordinate system, and an axis perpendicular to the Z-axis and the Y-axis is referred to as an X-axis of the rectangular coordinate system.

### First Preferred Embodiment

An angular acceleration sensor 10 according to a first preferred embodiment of the present invention will be described below.

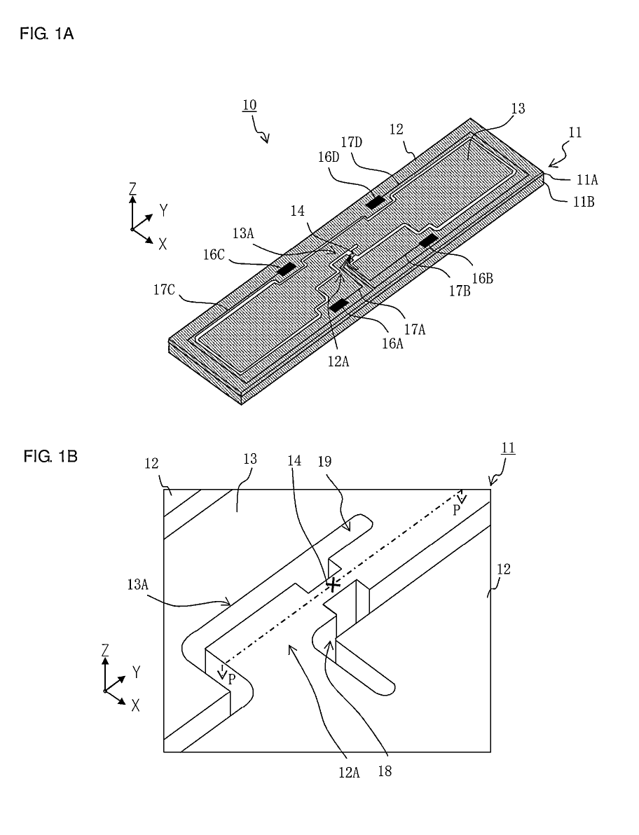

FIG. 1A is a perspective view of the angular acceleration sensor 10.

The angular acceleration sensor 10 includes a base plate section 11, piezoresistors 15A, 15B, 15C, and 15D, terminal electrodes 16A, 16B, 16C, and 16D, and wires 17A, 17B, 17C, and 17D. In FIG. 1, illustrations of the piezoresistors 15A, 15B, 15C, and 15D are omitted.

The base plate section 11 preferably is shaped like a rectangular or substantially rectangular flat plate having a longer-side direction along the Y-axis, a shorter-side direction along the X-axis direction, and a thickness direction along the Z-axis. The base plate section 11 includes an opening penetrating two surfaces opposed to each other in the Z-axis direction to define a fixed portion 12, a weight portion 13, and a beam portion 14.

Further, the base plate section 11 is formed preferably by surface-machining an SOI (Silicon On Insulator) substrate, and includes an SOI layer 11A located on the Z-axis positive side and a base layer 11B located on the Z-axis negative side. Surface machining of the SOI substrate matures in the machining technique and performance of a machining apparatus, and efficiently manufactures a plurality of rectangular or substantially rectangular plates with high accuracy. The SOI layer 11A and the base layer 11B are insulated by an insulating film. The SOI layer 11A and the base layer 11B are each preferably made of a silicon-based material, and the insulating film is preferably made of an insulating material such as silicon dioxide (SiO₂).

In the X-Y plane, the fixed portion 12 is annularly provided in an outer peripheral portion of the base plate section 11, and surrounds the weight portion 13 and the beam portion 14. That is, the weight portion 13 and the beam portion 14 are provided within an opening of the fixed portion 12. The fixed portion 12 is fixed to an unillustrated housing or the like.

The beam portion 14 is preferably shaped like a rectangle or an approximate rectangle having an extending direction along the Y-axis and a widthwise direction along the X-axis direction in the X-Y plane. The beam portion 14 is connected at a Y-axis negative side end portion to the fixed portion 12, is connected at a Y-axis positive side end portion to the weight portion 13, and is supported by the fixed portion 12 while being suspended from the unillustrated housing or the like.

The weight portion 13 has a shorter-side direction along the X-axis and a longer-side direction along the Y-axis in the X-Y plane. In the X-Y plane, the weight portion 13 is movably supported by the fixed portion 12 with the beam portion 14 being disposed therebetween while being suspended from the unillustrated housing or the like.

More specifically, in the X-Y plane, the center of an X-axis positive side of the weight portion 13 is recessed in the X-axis negative direction in a plurality of steps (for example, three steps), and a rectangular or substantially rectangular recessed portion 13A is provided in the innermost portion of the recess. The X-axis negative direction corresponds to the first direction. In the X-Y plane, the fixed portion 12 projects in the X-axis negative direction in a plurality of steps (for example, three steps) to be opposed to the three steps of the recess in the X-axis positive side of the weight portion 13, and a rectangular or substantially rectangular projecting portion 12A is provided in the top portion of the projecting area. The recessed portion 13A includes a wall surface facing in the Y axis negative direction, a wall surface facing in the X-axis positive direction, and a wall surface facing in the Y-axis positive direction. The projecting portion 12A includes a wall surface facing in the Y-axis positive direction, a wall surface facing in the X-axis negative direction, and a wall surface facing in the Y-axis negative direction. The wall surfaces of the recessed portion 13A and the corresponding wall surfaces of the projecting portion 12A are opposed to each other across the opening. The beam portion 14 extends in the Y-axis positive direction from the wall surface of the projecting portion 12A facing in the Y-axis positive direction, and is connected to the wall surface of the recessed portion 13A facing in the Y-axis negative direction. The Y-axis positive direction corresponds to the second direction.

By giving the above-described shapes to the weight portion 13 and the fixed portion 12, the beam portion 14 is able to be disposed at the gravitational center position of the weight portion 13 in the X-Y plane. Then, when an angular acceleration about the Z-axis acts on the weight portion 13, even when the weight portion 13 is supported by the single beam portion 14, the rotational balance is achieved, all rotary inertia force concentrates in the beam portion 14, and the beam portion 14 is greatly deflected. Further, both end portions in the Y-axis direction of the weight portion 13 located at positions apart from the beam portion 14 are wide in the X-axis direction, and the mass concentrates at the end portions in the Y-axis direction. Hence, the moment of inertia acting on the beam portion 14 due to the angular acceleration about the Z-axis increases. From these, in the angular acceleration sensor 10, the beam portion 14 is easily deflected by the angular acceleration about the Z-axis, and this improves the detection sensitivity to the angular acceleration.

The terminal electrodes 16A, 16B, 16C, and 16D are provided on a Z-axis positive side surface of the fixed portion 12. The terminal electrode 16A and the terminal electrode 16B are arranged along an X-axis positive side of the fixed portion 12, and the terminal electrode 16C and the terminal electrode 16D are arranged along an X-axis negative side of the fixed portion 12. Further, the terminal electrode 16A is disposed in a Y-axis negative side portion of the X-axis positive side of the fixed portion 12, and the terminal electrode 16B is disposed in a Y-axis positive side portion of the X-axis positive side of the fixed portion 12. The terminal electrode 16C is disposed in a Y-axis negative side portion of the X-axis negative side of the fixed portion 12, and the terminal electrode 16D is disposed in a Y-axis positive side portion of the X-axis negative side of the fixed portion 12.

The wires 17A, 17B, 17C, and 17D are provided on Z axis positive side surfaces of the fixed portion 12 and the beam portion 14. The wire 17A is connected at one end to the terminal electrode 16A and is connected at the other end to a piezoresistor 15A to be described later. The wire 17B is connected at one end to the terminal electrode 16B and is connected at the other end to a piezoresistor 15B to be described later. The wire 17C is connected at one end to the terminal electrode 16C and is connected at the other end to a piezoresistor 15C to be described later. The wire 17D is connected at one end to the terminal electrode 16D and is connected at the other end to a piezoresistor 15D to be described later. For this reason, the terminal electrode 16A is electrically connected to the piezoresistor 15A via the wire 17A, the terminal electrode 16B is electrically connected to the piezoresistor 15B via the wire 17B, the terminal electrode 16C is electrically connected to the piezoresistor 15C via the wire 17C, and the terminal electrode 16D is electrically connected to the piezoresistor 15D via the wire 17D.

FIG. 1B is a perspective view illustrating a peripheral structure of the beam portion 14 in the base plate section 11.

The center position of the beam portion 14 in the X-Y plane (shown by a cross in the figure) coincides with the gravitational center position of the weight portion 13. Further, the beam portion 14 is plane-symmetrical with respect to a stress neutral plane P. The stress neutral plane P is a Y-Z plane passing through the center position of the beam portion 14. The beam portion 14 is also plane-symmetrical with respect to an X-Z plane passing through the center position.

Slight elastic deformation is caused in the weight portion 13 and the fixed portion 12 by the action of the inertial force and gravity because the weight portion 13 and the fixed portion 12 are not perfectly rigid bodies. If the stress balance in the beam portion 14 is disturbed by transmission of the elastic deformation of the beam portion 14, unnecessary output from the piezoresistors occurs although the angular acceleration is not applied.

Accordingly, herein, the fixed portion 12 includes a slit 18 whose inner wall surface is defined by a wall surface of the fixed portion 12. The slit 18 extends in the Y-axis negative direction from an X-axis positive side end of the wall surface of the projecting portion 12A facing in the Y-axis positive direction in the X-Y plane, bends at a distal end in the Y-axis negative direction, and extends in the X-axis positive direction.

By thus extending the slit 18 in the Y-axis negative direction, the projecting portion 12A is made plane-symmetrical with respect to the stress neutral plane P in proximity to the beam portion 14. Then, even when elastic deformation occurs in the fixed portion 12 and stress is generated in the beam portion 14, the stress distribution in the beam portion 14 is plane-symmetrical with respect to the stress neutral plane P. Therefore, the occurrence of unnecessary output from the piezoresistors is prevented.

By bending and extending the slit 18 in the X-axis positive direction, even when deflection deformation or torsional deformation occurs over the entire fixed portion 12, transmission of distortion to the projecting portion 12A is significantly reduced or prevented. This prevents transmission of the distortion to the beam portion 14, and prevents the piezoresistors 15A to 15D from outputting unnecessary electric signals resulting from a factor other than the angular acceleration around the detection axis.

By further providing a slit 19, whose inner wall surface is defined by a wall surface of the weight portion 13, in the weight portion 13, the recessed portion 13A is made plane-symmetrical with respect to the stress neutral plane P in proximity to the beam portion 14. The slit 19 extends in the Y-axis positive direction from an X-axis negative side end of the wall surface of the recessed portion 13A facing in the Y-axis negative direction in the X-Y plane. That is, the slit 19 extends inward in the Y-axis positive direction (second direction) from the recessed portion 13A. By making the recessed portion 13A plane-symmetrical with respect to the stress neutral plane P passing through the center of the beam portion 14, even when the weight portion 13 elastically deforms and the stress is generated in the beam portion 14, the stress distribution in the beam portion 14 is plane-symmetrical with respect to the stress neutral plane P. Therefore, this also prevents unnecessary output from the piezoresistors.

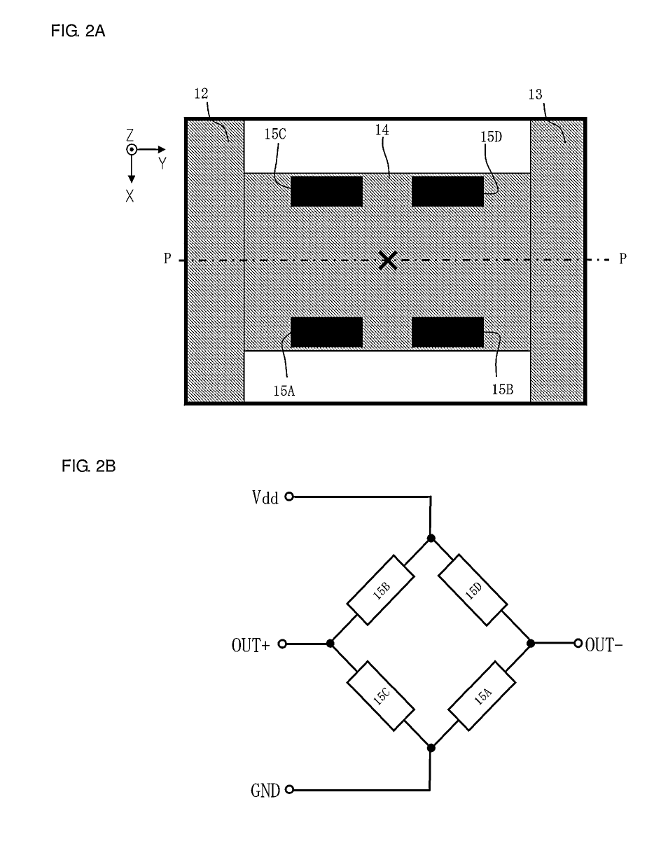

FIG. 2A illustrates the piezoresistors 15A, 15B, 15C, and 15D provided in the beam portion 14.

The piezoresistors 15A, 15B, 15C, and 15D constitute the detection portion in the present preferred embodiment, and are provided on the Z-axis positive side surface of the beam portion 14. As described above, the piezoresistor 15A is connected to the wire 17A, the piezoresistor 15B is connected to the wire 17B, the piezoresistor 15C is connected to the wire 17C, and the piezoresistor 15D is connected to the wire 17D. In FIG. 2, illustrations of the wires 17A, 17B, 17C, and 17D are omitted. The piezoresistors 15A, 15B, 15C, and 15D are formed preferably by diffusing (doping) p-type impurities in the SOI layer 11A in the beam portion 14.

The piezoresistor 15A is provided in an X-axis positive side end portion of the beam portion 14 and at a position shifted in the Y-axis negative direction from the center in the Y-axis direction in the X-Y plane. The piezoresistor 15B is provided in the X-axis positive side end portion of the beam portion 14 and at a position shifted in the Y-axis positive direction from the center in the Y-axis direction in the X-Y plane. The piezoresistor 15C is provided in an X-axis negative side end portion of the beam portion 14 and at a position shifted in the Y-axis negative direction from the center in the Y-axis direction in the X-Y plane. The piezoresistor 15D is provided in the X-axis negative side end portion of the beam portion 14 and at a position shifted in the Y-axis positive direction from the center in the Y-axis direction in the X-Y plane.

The piezoresistors 15A, 15B, 15C, and 15D are arranged plane-symmetrically with respect to the Y-Z plane (stress neutral plane) passing through the center position of the beam portion 14 and plane-symmetrically with respect to the X-Z plane passing through the center position of the beam portion 14.

FIG. 2B is a circuit diagram explaining the schematic configuration of a detection circuit constituted by the piezoresistors 15A, 15B, 15C, and 15D.

The piezoresistor 15A and the piezoresistor 15D are connected in series. The piezoresistor 15B and the piezoresistor 15C are connected in series. A series circuit defined by the piezoresistors 15A and 15D and a series circuit defined by the piezoresistors 15B and 15C are connected to each other in parallel. A connecting point between the piezoresistor 15B and the piezoresistor 15D is connected to an output terminal Vdd of a constant voltage source, and a connecting point between the piezoresistor 15A and the piezoresistor 15C is connected to a ground GND. Further, a connecting point between the piezoresistor 15A and the piezoresistor 15D is connected to an output terminal OUT₋, and a connecting point between the piezoresistor 15B and the piezoresistor 15C is connected to an output terminal OUT₊.

Thus, the piezoresistors 15A, 15B, 15C, and 15D configure a Wheatstone bridge circuit. The piezoresistor 15A and the piezoresistor 15D that define the series circuit and the piezoresistor 15B and the piezoresistor 15C that define the series circuit in the Wheatstone bridge circuit are provided on opposite sides of the center of the beam portion 14. Therefore, potentials of output signals from the output terminals OUT₊ and OUT₋ are changed in opposite polarities by deflection of the beam portion 14 along the X-axis. Hence, the angular acceleration about the Z-axis is able to be measured by utilizing the potential difference therebetween. By providing the Wheatstone bridge circuit, the detection sensitivity of the angular acceleration sensor 10 is higher than the detection sensitivity of an angular acceleration sensor in which a detection circuit is defined by a resistance voltage dividing circuit including two piezoresistors.

### Second Preferred Embodiment

Next, a base plate section 21 that constitutes an angular acceleration sensor according to a second preferred embodiment of the present invention will be described.

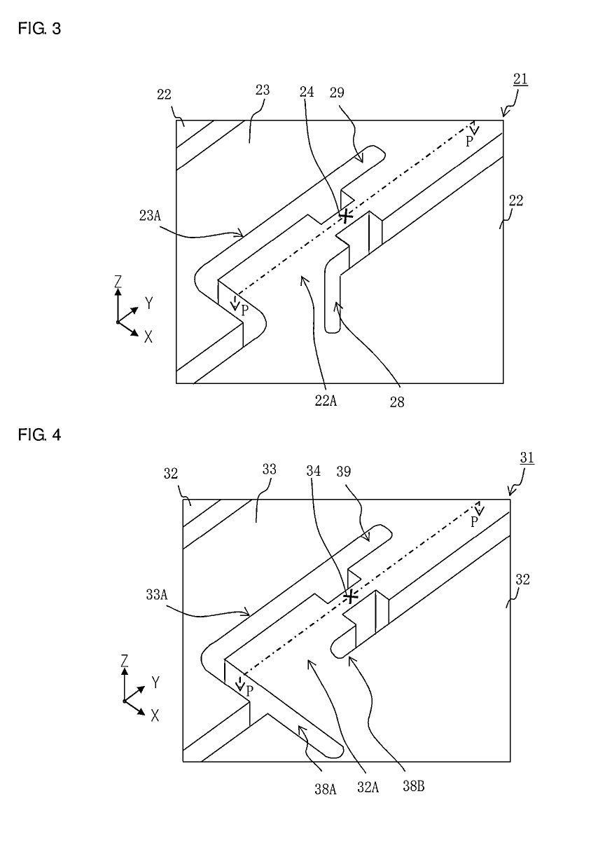

FIG. 3 is a perspective view illustrating a peripheral structure of a beam portion in the base plate section 21.

In the second preferred embodiment, similarly to the first preferred embodiment, the base plate section 21 includes a fixed portion 22, a weight portion 23, and a beam portion 24. The fixed portion 22 includes a projecting portion 22A, and the weight portion 23 includes a recessed portion 23A and a slit 29.

The fixed portion 22 further includes a slit 28 whose inner wall surface is defined by a wall surface of the fixed portion 22. The slit 28 extends in the Y-axis negative direction from an X-axis positive side end of a wall surface of the projecting portion 22A facing in the Y-axis positive direction in the X-Y plane, bends, and extends in a direction that bisects the space between the X-axis positive direction and the Y-axis negative direction. That is, the slit 28 extends in the Y-axis negative direction, bends, and then extends in the direction intersecting the X-axis and the Y-axis in the X-Y plane.

Thus, in the fixed portion 22, the slit 28 extending in the direction intersecting the X-axis and the Y-axis, transmission of distortion to the projecting portion 22A is also significantly reduced or prevented even when deflection deformation or torsional deformation occurs over the entire fixed portion 22.

### Third Preferred Embodiment

Next, a base plate section 31 that constitutes an angular acceleration sensor according to a third preferred embodiment of the present invention will be described.

FIG. 4 is a perspective view illustrating a peripheral structure of a beam portion in the base plate section 31.

In the third preferred embodiment, similarly to the first preferred embodiment, the base plate section 31 includes a fixed portion 32, a weight portion 33, and a beam portion 34. The fixed portion 32 includes a projecting portion 32A, and the weight portion 33 has a recessed portion 33A and a slit 39.

The fixed portion 32 further includes slits 38A and 38B whose inner wall surfaces are defined by wall surfaces of the fixed portion 32. In the X-Y plane, the slit 38A extends in the X-axis positive direction from an X-axis positive side end of a wall surface of the projecting portion 32A facing in the Y-axis negative direction. That is, the slit 38A extends inward in the X-axis positive direction (direction opposite from the first direction) from the projecting portion 32A. In the X-Y plane, the slit 38B extends in the Y-axis negative direction from an X-axis positive side end of a wall surface of the projecting portion 32A facing in the Y-axis positive direction. That is, the slit 38B extends inward in the Y-axis negative direction (direction opposite from the second direction) from the projecting portion 32A.

Thus, in the fixed portion 32, the slit 38B extending inward in the Y-axis negative direction (direction opposite from the second direction), the projecting portion 32A is made plane-symmetrical with respect to a stress neutral plane P passing through the center of the beam portion 34 in proximity to the beam portion 34. Therefore, even when the projecting portion 32A is elastically deformed and stress is generated in the beam portion 34, the stress distribution in the beam portion 34 is made plane-symmetrical with respect to the stress neutral plane P. By further providing, in the fixed portion 32, the slit 38A extending inward in the X-axis positive direction (direction opposite from the first direction), even when deflection deformation or torsional deformation occurs over the entire fixed portion 32, transmission of distortion to the projecting portion 32A is significantly reduced or prevented.

### Fourth Preferred Embodiment

Next, a base plate section 41 that constitutes an angular acceleration sensor according to a fourth preferred embodiment of the present invention will be described.

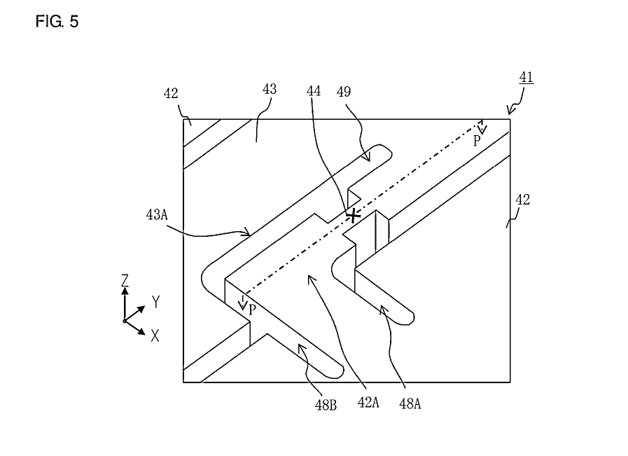

FIG. 5 is a perspective view illustrating a peripheral structure of a beam portion in the base plate section 41.

In the fourth preferred embodiment, similarly to the third preferred embodiment, the base plate section 41 includes a fixed portion 42, a weight portion 43, and a beam portion 44. The fixed portion 42 includes a projecting portion 42A and a slit 48A, and the weight portion 43 has a recessed portion 43A and a slit 49.

Similarly to the first preferred embodiment, the fixed portion 42 further includes a slit 48B.

In this way, a plurality of slits extending inward in the X-axis positive direction (direction opposite from the first direction) from the projecting portion 42A may be provided.

### Comparison Test

Next, a description will be given of the distribution of stress acting on the base plate section when torsion is applied to four outer corner portions of the fixed portion.

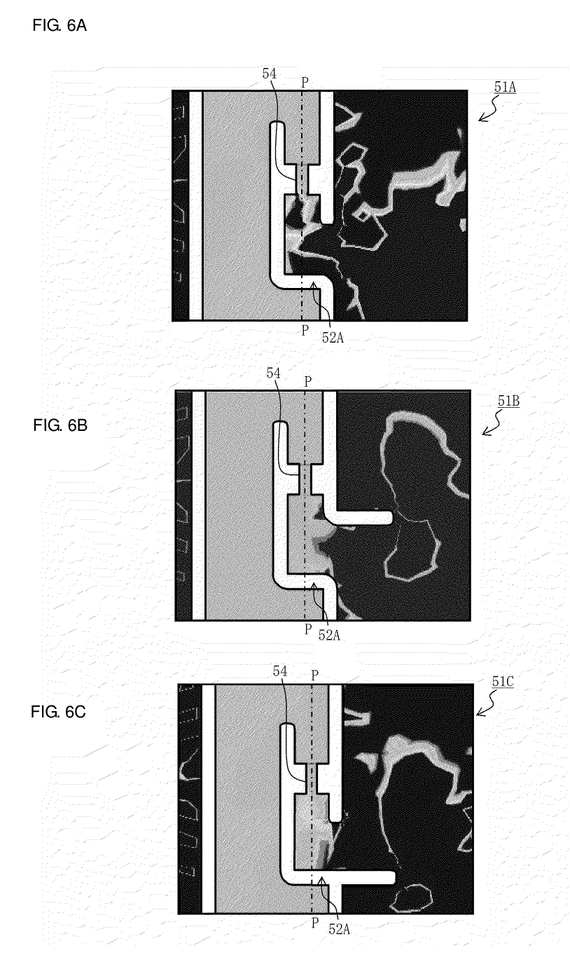

FIGS. 6A-6C are contour diagrams showing the stress distribution in the peripheral structure of the beam portion. FIG. 6A shows a stress distribution in a base plate section 51A of a comparative structure in which a projecting portion does not have a slit extending inward in the X-axis positive direction (direction opposite from the first direction). FIG. 6B shows a stress distribution in a base plate section 51B of the structure of the present application in which a slit extending inward in the X-axis positive direction (direction opposite from the first direction) is provided on the Y-axis positive side of a projecting portion. FIG. 6C shows a stress distribution in a base plate section 51C of the structure of the present application in which a slit extending inward in the X-axis positive direction (direction opposite from the first direction) is provided on the Y-axis negative side of a projecting portion.

In the figures, grayscale display schematically shows the distribution of absolute stress values. For example, two dark displayed regions separated by a light displayed region in the fixed portion are opposite in stress polarity and substantially equal in absolute stress value.

In the base plate section 51A of the comparative structure, the stress is distributed to the inside of a projecting portion 52A, and the stress is also partially distributed in proximity of an end portion of a beam portion 54. In contrast, in the base plate section 51B and the base plate section 51C of the structures of the present application, the stress is only partially distributed in the inside of the projecting portion 52A, and the stress is hardly distributed in proximity to the end portion of the beam portion 54.

In this way, it is confirmed by the comparison test of the stress distribution that, when the slit extending inward in the X-axis positive direction (direction opposite from the first direction) is provided in proximity to the projecting portion as in the structures of various preferred embodiments of the present invention, the stress is not transmitted to the beam portion, and the occurrence of unnecessary output from the piezoresistors is prevented.

While each slit preferably has a linear or bent shape in the above-described preferred embodiments, each slit may have a curved shape or a shape formed by a combination of curves.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. (canceled)

2. An angular acceleration sensor comprising:
a flat plate surface;
a weight portion including a recessed portion that is recessed in a first direction in the flat plate surface;
a fixed portion including a projecting portion that projects in the first direction in the flat plate surface to be opposed to the recessed portion;
a beam portion extending from the projecting portion in a second direction perpendicular or substantially perpendicular to the first direction in the flat plate surface and being connected to the recessed portion at an end portion in the second direction; and
a detection portion configured to detect stress generated in the beam portion;
wherein
a slit extending in a direction intersecting the second direction from a position adjacent to the projecting portion in the flat plate surface extends inward in the fixed portion.

3. The angular acceleration sensor according to claim 2, wherein the slit extends in a direction opposite from the first direction in the flat plate surface.

4. The angular acceleration sensor according to claim 2, wherein the slit extends in a direction opposite from the second direction, bends, and extends in a direction opposite from the first direction in the flat plate surface.

5. The angular acceleration sensor according to claim 2, wherein the slit extends in a direction intersecting the first direction and the second direction in the flat plate surface.

6. The angular acceleration sensor according to claim 2, wherein the fixed portion surrounds a periphery of the weight portion in the flat plate surface.

7. The angular acceleration sensor according to claim 2, wherein the fixed portion surrounds the weight portion and the beam portion.

8. The angular acceleration sensor according to claim 2, wherein the fixed portion includes an opening in which the weight portion and the beam portion are provided.

9. The angular acceleration sensor according to claim 2, wherein the weight portion is movably supported by the fixed portion.

10. The angular acceleration sensor according to claim 2, wherein the recessed portion includes a plurality of steps and the projecting portion includes a plurality of steps opposed to the plurality of steps of the recessed portion.

11. The angular acceleration sensor according to claim 2, wherein the recessed portion includes a plurality of wall portions and the projecting portion includes a plurality of wall portions opposed to the plurality of wall portions of the recessed portion.

12. The angular acceleration sensor according to claim 2, wherein the recessed portion is plane-symmetrical with respect to a stress neutral plane.

13. The angular acceleration sensor according to claim 2, wherein the slit is defined by a wall surface of the fixed portion.

14. The angular acceleration sensor according to claim 2, wherein the detection portion includes a plurality of piezoresistors.

15. The angular acceleration sensor according to claim 2, wherein the plurality of piezoresistors are connected to define a Wheatstone bridge circuit.

16. The angular acceleration sensor according to claim 2, wherein the slit is provided in the weight portion, and another slit is provided in the fixed portion.

17. The angular acceleration sensor according to claim 16, wherein the another slit is defined by a wall portion of the fixed portion.

18. The angular acceleration sensor according to claim 2, wherein the slit is provided in the weight portion, and a plurality of other slits is provided in the fixed portion.

19. The angular acceleration sensor according to claim 18, wherein the plurality of other slits are defined by wall surfaces of the fixed portion.

20. The angular acceleration sensor according to claim 2, wherein the slit has one of a linear shape, a bent shape, and a curved shape.
